(19) United States
(12) Patent Application Publication
(10) Pub. No.: US 2009/0113522 A1
(43) Pub. Date: Apr. 30, 2009

(54) Method for Translating an Authentication Protocol

(76) Inventors: Magali Crassous, Issy Les Moulineaux (FR); Claire Duranton, Versailles (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/922,463

(22) PCT Filed: Jun. 7, 2006
(86) PCT No.: PCT/FR2006/050529

§ 371 Date: Dec. 17, 2007

(30) Foreign Application Priority Data
Jun. 16, 2005 (FR) 0506136

(51) Int. Cl. H04L 9/32; H04L 29/06

(52) U.S. Cl. 726/4; 726/5

(57) ABSTRACT

A method of translating messages conforming to a first authentication protocol into messages conforming to a second authentication protocol during an authentication phase in which a peer, having an identity and seeking to access a resource of a network, is connected to an authenticator, said authenticator authorizing access to the network as a function of verification of the identity and rights of the peer effected by an authentication server as a function of authentication data received in messages conforming to the second authentication protocol. The translation method comprises: a step of receiving the identity of the peer in a message conforming to the first authentication protocol, a step of generating and sending a challenge, a step of receiving a first response that is a response to said challenge, generating a request for access to the network conforming to the second authentication protocol, and sending said request to the authentication server, a step of receiving a second response that is a response to said request and translating the second response to generate an authentication result conforming to the first authentication protocol.

The invention relates to a method of translating messages conforming to a first authentication protocol into messages conforming to a second authentication protocol during an authentication phase during which a peer, having an identity and seeking to access a resource of a network, connects to an authenticator, said authenticator authorizing access to the network as a function of verification of the identity and rights of the peer effected by an authentication server as a function of authentication data received in messages conforming to the second authentication protocol.

The field of the present invention is that of telecommunications and networks.

It is known that users who wish to access an IP network and who subscribe to an access service from an Internet Service Provider (ISP) must be authenticated beforehand to the ISP. Authentication checks that an identified person is indeed who they claim to be, for example through the use of a password. This enables subsequent verification that they have rights to access a physical resource.

A client, consisting of a machine and a user, is authenticated by an authentication server that recovers client authentication data during a dialogue based on an authentication protocol.

The protocol most widely used and most widely installed by network equipment installers is the RADIUS (Remote Authentication Dial In User Service) protocol in conjunction with PPP (Point to Point Protocol), both from the IETF (Internet Engineering Task Force) (see http://www.ietf.org/rfc.rfc2865.txt and http://www.ietf.org/rfc/rfc1661.txt). Authentication servers that support the RADIUS protocol are called RADIUS servers.

PPP supports various authentication methods, for example, and non-exhaustively, the PPP CHAP (Point to Point Protocol Challenge Handshake Authentication Protocol) method from the IETF (see http://www.ietf.org/rfc/rfc1994.txt) and the PPP EAP (Point to Point Protocol Extensible Authentication Protocol) method also from the IETF (see http://www.ietf.org/rfc/rfc3748.txt).

The PPP CHAP method periodically verifies the identity of a client by sending the client a PPP CHAP request containing a challenge that consists of a random value. The client sends in return a value calculated from data including the challenge and a secret that it holds, thus enabling the RADIUS server to check the identity of the client by calculating a value from the same data. The secret is a password specific to the user and known to the RADIUS server.

EAP authenticates a client seeking to be associated with an access network and has the particular feature that it defines generic exchanges for transporting diverse EAP authentication methods. EAP supports a dozen EAP authentication methods, for example, and non-exhaustively, the EAP MD5-Challenge method from the IETF (see http://www.ietf.org/rfc/rfc3748.txt), and the EAP-TTLS (Tunneled Transport Layer Security) method currently under discussion at the IETF (see http://www.ietf.org/internet-drafts/draft-funk-eap-ttls-v 1-00.txt). The generic nature characteristic of EAP makes it a highly-flexible protocol that is being used more and more.

The EAP MD5-Challenge method is the simplest of the EAP authentication methods to use: authentication is effected by sending the client an EAP MD5-Challenge type request containing a challenge. The client responds by hashing the challenge using an MD5 (Message Digest-5) hashing function defined by the IETF (see http://www.ietf.org/rfc/rfc1321.txt) and using as a parameter a secret that consists of the user's password. The RADIUS server checks the identity of the client by calculating a value from the same data.

The two authentication mechanisms, RADIUS for PPP CHAP and RADIUS for EAP MD5-Challenge, exist and function separately. However, an EAP MD5-Challenge client cannot be authenticated to a RADIUS server supporting the PPP CHAP authentication method but not having an EAP function necessary for EAP MD5-Challenge authentication. Many servers already installed in the network do not have the EAP function enabling the server to authenticate an EAP MD5-Challenge client.

An object of the present invention is to remove the drawbacks of the prior art by proposing a translation method adapted to authenticate an EAP MD5-Challenge client to a PPP CHAP-RADIUS server that does not support EAP.

That object is achieved by a method according to the invention as described in the introductory paragraph and characterized in that it comprises:
a step of receiving the identity of the peer in a message conforming to the first authentication protocol;
a step of generating and sending a challenge;
a step of receiving a first response that is a response to said challenge, generating a request for access to the network conforming to the second authentication protocol, and sending said request to the authentication server; and
a step of receiving a second response that is a response to said request and translating the second response to generate an authentication result conforming to the first authentication protocol.

The advantages of this method are considerable:
an EAP MD5-Challenge client can be authenticated to a RADIUS server that does not have the EAP function;
no modification of the EAP MD5-Challenge client is necessary; and
no modification of the RADIUS server is necessary (this is an advantage if the RADIUS server is already operational in the network).

The translation method advantageously further comprises a step of choosing an authentication method supported by the first authentication protocol.

Thus methods based on encapsulating EAP MD5-Challenge in a tunnel, such as the EAP-TTLS method, for example, are compatible with the translation method.

Generating the challenge advantageously comprises:
a step of requesting said challenge from the authentication server; and
a step of receiving said challenge.

The possibility of having an external server generate the challenge ensures compatibility with the standardized authentication methods used by the authentication method.

The invention also relates to a method of authenticating a peer having an identity and which, to access a resource of a network, is connected to an authenticator-translator conforming to a first authentication protocol, said authenticator-translator authorizing access to the network as a function of verification of the identity and rights of the peer effected by an authentication server as a function of authentication data received in messages conforming to a second authentication protocol, the method comprising:
a step of sending an identity request to the peer;
a step of receiving the identity of the peer in a message conforming to the first authentication protocol; and
a step of generating and sending a challenge; characterized in that the authentication method integrates functions for translating messages conforming to the first authentication protocol into messages conforming to the second authentication protocol and in that it further comprises:
a step of receiving a first response that is a response to said challenge, generating a network access request conforming to the second authentication protocol, and sending said request to the authentication server; and
a step of receiving a second response that is a response to said request, translating the second response to generate an authentication result conforming to the first authentication protocol, and sending said authentication result.

The invention further relates to a translator device adapted to translate messages conforming to a first authentication protocol into messages conforming to a second authentication protocol during an authentication phase in which a peer, having an identity and seeking to access a resource of a network, is connected to an authenticator, said authenticator authorizing access to the network as a function of verification of the identity and rights of the peer effected by an authentication server as a function of authentication data received in messages conforming to the second authentication protocol, characterized in that the translator device comprises:
a module for obtaining a challenge;
a module for sending said challenge and a network access request;
a module for receiving the identity of the peer, a first response that is a response to said challenge, and a second response that is a response to said network access request; and
a processor module that generates the network access request conforming to the second authentication protocol and translates an authentication result conforming to the first authentication protocol.

The translator device advantageously further comprises a module for choosing an authentication method supported by the first authentication protocol.

The invention also relates to an authenticator-translator device adapted to authenticate a peer having an identity and which, for access to a resource of a network, dialogues with said device in accordance with a first authentication protocol, said device authorizing access to the network as a function of verification of the identity and rights of the peer effected by an authentication server as a function of authentication data received in messages conforming to the second authentication protocol, the device comprising:
a module for obtaining a challenge;
a module for sending a peer identity request, said challenge, a network access request and an authentication result;
a module for receiving said identity, a first response that is a response to said challenge, and a second response that is a response to said network access request;
   characterized in that it is adapted to translate messages conforming to the first authentication protocol into messages conforming to the second authentication protocol and in that it comprises:
a processor module that generates the network access request conforming to the second authentication protocol and translates the authentication result conforming to the second authentication protocol.

The invention further relates to an authentication system comprising a peer seeking to access a resource of a network and that must be authenticated by an authenticator system by sending authentication data in compliance with a first authentication protocol, received and verified by an authentication server in accordance with a second authentication protocol, characterized in that it comprises:
means for translating the authentication data of the first protocol into authentication data of the second protocol; and
means for authenticating the client.

The means for translating the authentication data of the first protocol into authentication data of the second protocol are advantageously provided by the translator device.

The means for translating the authentication data of the first protocol into authentication data of the second protocol are advantageously provided by the authenticator-translator device.

The invention further relates to a computer program including instructions for executing the translation method according to the invention when it is executed by a microprocessor.

The invention further relates to a computer program including instructions for executing the authentication method according to the invention when it is executed by a microprocessor.

Numerous details and advantages of the invention can be better understood after reading the description of one particular embodiment with reference to the appended diagrams given by way of non-limiting example and in which:

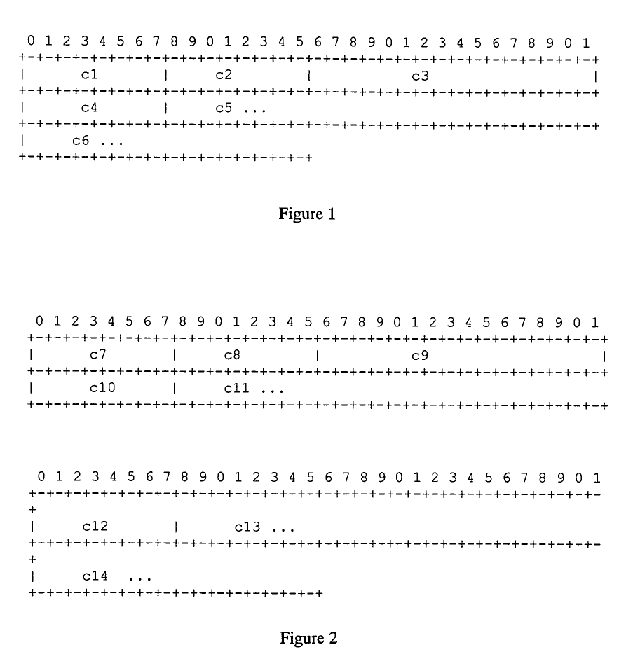

FIG. 1 is a diagram showing the format of prior art PPP CHAP challenge and response messages exchanged between a client to be authenticated and an authenticator system during the authentication phase.

FIG. 2 is a diagram showing the format of prior art EAP MD5-Challenge type EAP request or response type messages exchanged between a client to be authenticated and an authenticator system during the authentication phase.

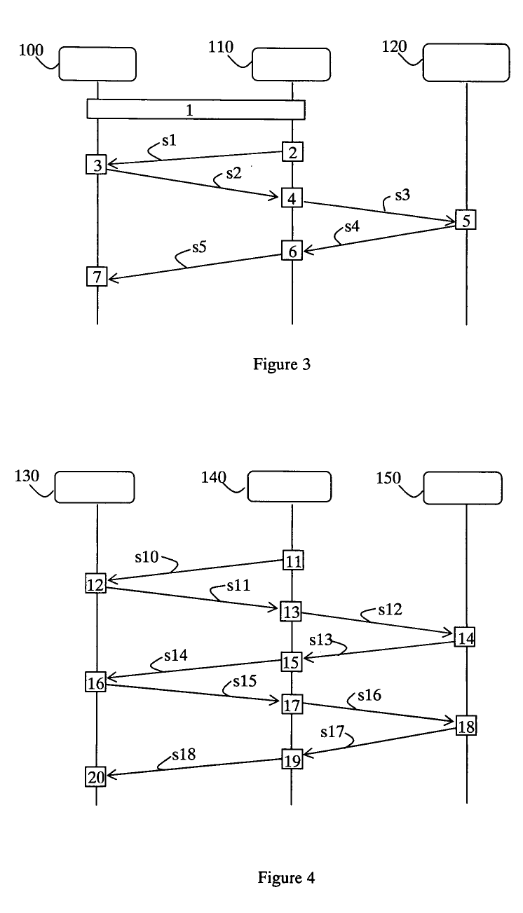

FIG. 3 is a diagram representing a prior art authentication method conforming to the PPP CHAP protocol.

FIG. 4 is a diagram representing a prior art authentication method conforming to the EAP protocol and to the EAP MD5-Challenge authentication method.

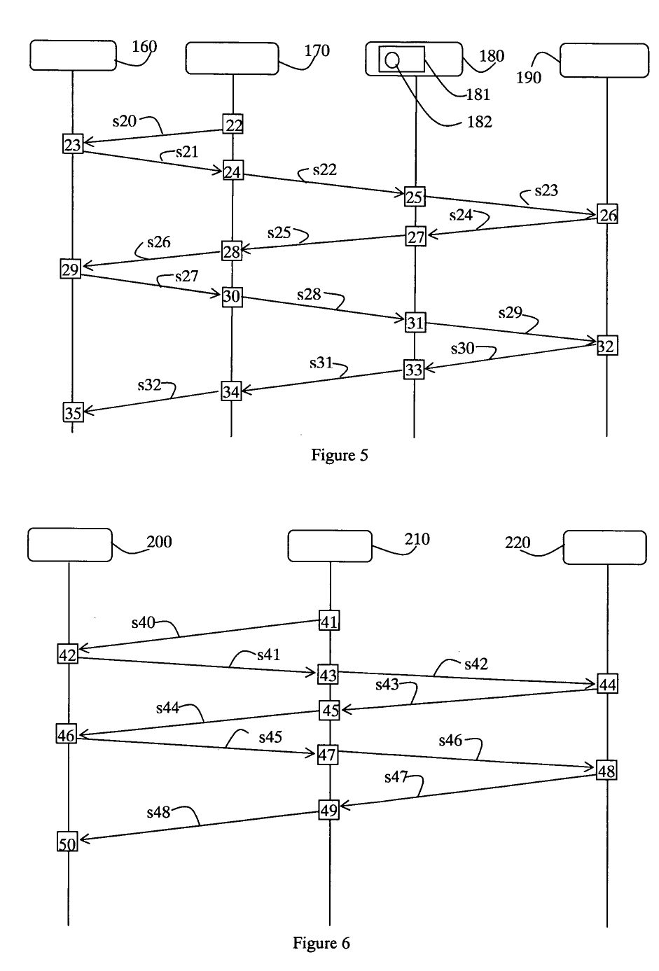

FIG. 5 is a diagram representing a first variant of a translation method according to the invention.

FIG. 6 is a diagram representing a second variant of a translation method according to the invention.

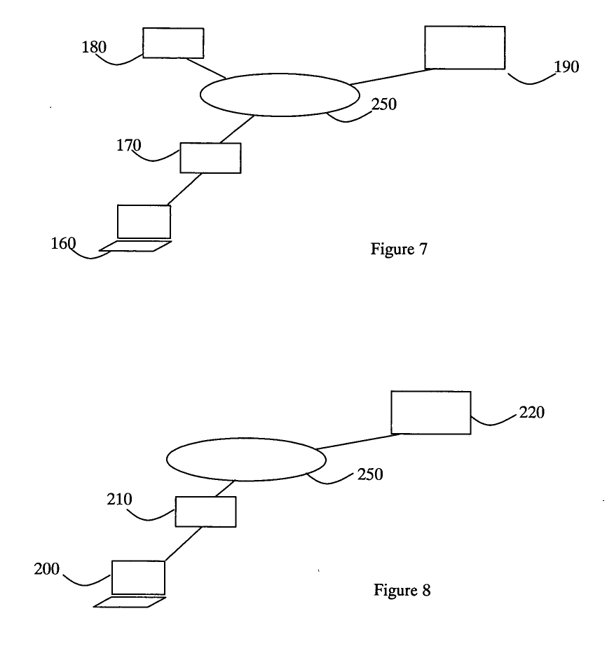

FIG. 7 is a diagram of a network architecture conforming to a first variant of the invention.

FIG. 8 is a diagram of a network architecture conforming to a second variant of the invention.

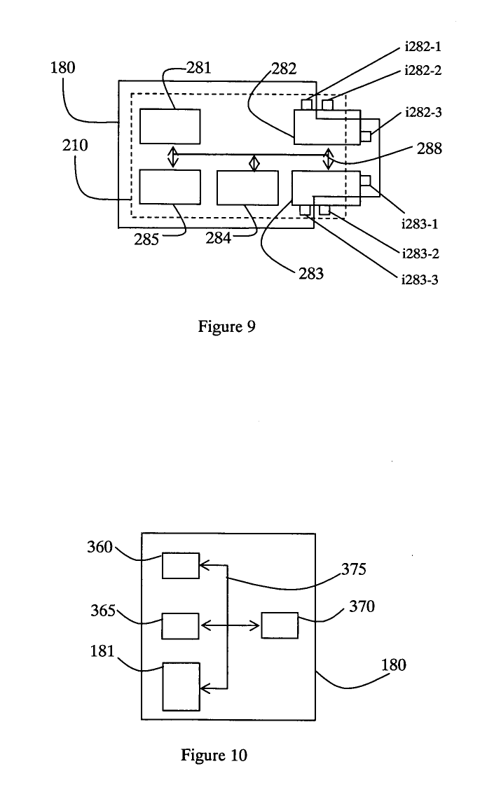

FIG. 9 is a diagram showing the functional organization of a translator and an authenticator-translator according to the invention.

FIG. 10 is a diagram including the main components of a translator according to the invention.

Three entities interact in a standard network authentication method: an authenticator system, a client to be authenticated, and an authentication server. The authenticator system controls access to a physical resource via an access point to the network. The client to be authenticated wishes to access the resource and must be authenticated to do this. The authentication server is the machine that, at the request of the authenticator system, verifies if the client to be authenticated is indeed who they claim to be and has the right to access the requested resource. If authentication succeeds, the authenticator system provides access to the resource that it controls. The authentication server manages authentication as such, in dialogue with the client to be authenticated on the basis of an established authentication protocol.

The client to be authenticated consists of a machine and a user. In most current network installations, the authenticator system is a network equipment, such as a wireless access station, for example, also known as an access point (AP), a switch/IP router called a Network Access Server (NAS) for PSTN (Public Switched Telephone Network) access or ADSL (Asymmetric Digital Subscriber Line) access. In the EAP and PPP CHAP terminology, the client to be authenticated is called a peer and the authenticator system is called the authenticator. The authentication server is typically a RADIUS server or any other equipment capable of performing the authentication. The RADIUS server is the equipment most widely used for authentication among Internet service providers in particular.

The RADIUS protocol functions in a client/server mode. The authenticator system functions as a RADIUS client. A RADIUS client sends RADIUS requests and acts as a function of the responses received. A RADIUS server can act as a RADIUS agent for other RADIUS servers and other authentication systems. The operating principle of the RADIUS protocol resides in the use of a secret, for example a password, held by the RADIUS server and the peer to be authenticated and that is not sent over the network for PPP CHAP authentication.

The RADIUS protocol enables user/password authentication or user/challenge/response authentication. It is based on an exchange of requests/responses that can be of four different types: Access-Request, Access-Accept, Access-Reject, and Access-Challenge.

A RADIUS client sends the RADIUS server an access authorization request, which is a RADIUS request of the Access-Request type. The RADIUS server sends an acceptance response, a rejection response or a response requesting additional information. An acceptance response is a RADIUS response of the Access-Accept type, a rejection response is a RADIUS response of the Access-Reject type, and a request for additional information response is a RADIUS response of the Access-Challenge type sent by the RADIUS server, which sends a challenge and awaits a response.

The RADIUS protocol transports authentication and authorization information in RADIUS request fields, for example in information elements known as attributes. The number of attributes in a RADIUS message varies. There can be no, one or more attributes. Each attribute has a type that qualifies it, a value, and a size. By way of non-limiting example, a User-Name type attribute corresponds to an identifier or a login of a user to be authenticated, a CHAP-Challenge type attribute corresponds to a PPP CHAP challenge generated by an authenticator system and sent to the client to be authenticated, a CHAP-Password type attribute corresponds to a response to a PPP CHAP challenge sent by the client to be authenticated, and a Reply-Message type attribute, when sent in a RADIUS request of the Access-Challenge type, contains a challenge. Authentication elements can also be contained in an authenticator field of a RADIUS request/response.

FIG. 1 shows the format of prior art challenge and response messages conforming to the PPP CHAP protocol. The challenge and response messages are exchanged between a peer and an authenticator.

A first field c1 qualifies the message type according to whether it is a challenge or a response to the challenge. The field c1 has the name Code.

A second field c2, which has the name Identifier, contains a value that identifies an exchange of messages. It must be changed each time that a new challenge is sent. For a message in response to the challenge, the value of the field is the same as the value of the Identifier field of the challenge message.

A third field c3, which has the name Length, contains the size of the PPP CHAP message.

A fourth field c4, which has the name Value-Size, corresponds to the length of a fifth field c5 which has the name Value defined below.

The fifth field c5, which has the name Value, contains the value of the challenge or the response to the challenge. A challenge is a random value that is changed each time that a new challenge is sent. The response to the challenge is calculated by applying a hashing function to a byte stream consisting of the value of the Identifier field c2 followed by a secret known to the user associated with the peer and the authentication server followed by the value of the challenge. For PPP CHAP, the hashing function is MD5. The secret is a password specific to the user.

A sixth field c6, which has the name Name, corresponds to the identification of the system that sends the message.

FIG. 2 illustrates the format of a prior art EAP request or response. EAP requests and responses are exchanged between a peer and an authenticator.

A first field c7, which has the name Code, specifies a request or a response to the request.

A second field c8, which has the name Identifier, identifies an exchange of messages: the field c8 of a response will be the same as the field c8 of the request that generates the response.

A third field c9, which has the name Length, specifies the length of the EAP message.

A fourth field c10, which has the name Type, specifies the request or response type. For example, a particular type called Identity corresponds to an identity request or a response to the identity request. A response message to an identity request contains in a fifth field c11, which has the name Type-Data, the identity of the user associated with the peer. Another type of request that is specified in the field c10 corresponds to an EAP authentication method. For example, a type which has the name MD5-Challenge specifies that the EAP authentication method is the EAP MD5-Challenge method. The type MD5-challenge is analogous to the PPP CHAP protocol with the MD5 hashing function. The field c11, which has the name Type-Data, then consists of the following fields:
a sixth field c12, which has the name Value-Size, and is comparable to the field c4 of FIG. 1, corresponds to the length of the field c13;
a seventh field c13, which has the name Value, and is comparable to the field c5 of FIG. 1, corresponds to a challenge or a response to that challenge; and
a eighth field c14, which has the name Name, and is comparable to the field c6 of FIG. 1, corresponds to the identification of a system that sends the EAP request or response.

FIG. 3 illustrates the prior art PPP CHAP-RADIUS authentication mechanism, showing messages exchanged between three entities that the authentication method concerns. A Network Access Server (NAS) 110 designates the authenticator system. The NAS 110 controls access of the peer 100 to a physical resource of the network. A RADIUS server 120 is the authentication server responsible for authenticating the peer 100. The format of the PPP CHAP challenge and response messages exchanged between the peer 100 and the NAS 110 conforms to that illustrated by FIG. 1.

In an initial state 1, the peer 100 and the NAS 110 are in a PPP negotiation phase during which the peer 100 and the NAS 110 set up a PPP link and agree on the authentication method to be used. In particular, it is in this phase that the PPP CHAP authentication method is chosen.

In a step 2, following the PPP negotiation phase that took place in the initial state 1, the NAS 110 generates a challenge and sends to the peer 100 a PPP CHAP challenge message s1 that includes the challenge. In an alternative implementation of PPP CHAP-RADIUS authentication, not represented in FIG. 3, the NAS 110 delegates generation of the challenge to the RADIUS server 120: the NAS server 110 sends an Access-Request type RADIUS request to the RADIUS server 120, which responds with an Access-Challenge type RADIUS response that contains the challenge in a RADIUS attribute which has the name Reply-Message. It is possible to specify the identity of the NAS 110 that is sending the message in the field c6 of the PPP CHAP challenge message. In the alternative implementation of authentication in which the challenge is generated by the RADIUS server 120, it is possible to specify the identity of the RADIUS server 120 that generated the challenge in the field c6.

In a step 3, following on from reception of the PPP CHAP challenge message s1, the peer 100 extracts the value of the challenge from the PPP CHAP challenge message s1 and calculates a response to that challenge. The response is calculated by applying an MD5 hashing function to data consisting of the value of the field c2 of the PPP CHAP challenge message s1 following by a secret held by the peer 100 followed by the value of the challenge received in the PPP CHAP challenge message s1 and that appears in the field c5 of the message s1. At the end of step 3, the peer 100 sends the response in a PPP CHAP response message s2. The field c6 is used to specify the identity of the peer 100 that is sending the message.

In a step 4, following on from reception of the PPP CHAP response message s2, the NAS 110 generates an Access-Request type RADIUS request s3 for the attention of the RADIUS server 120. The request comprises the following RADIUS attributes:
a RADIUS attribute User-name the value of which is the identifier of the peer 100. The value of the RADIUS attribute User-name is recovered from the field c6 of the PPP CHAP response message s2;
a RADIUS attribute CHAP-Challenge the value of which corresponds to the challenge calculated by the NAS 110 during step 2. In the alternative implementation of authentication in which the challenge was generated by the RADIUS server 120 in the step 2, the CHAP-Challenge attribute need not be sent;
a RADIUS attribute CHAP-Password the value of which is the identity of the PPP CHAP message s1 specified in the field c2 of the PPP CHAP message s1 and the response to the challenge received in the step 4 in the PPP CHAP response message s2. In the alternative implementation of authentication in which the challenge was generated by the RADIUS server 120 in step 2, and if the attribute CHAP-Challenge is not sent in the Access-Request type RADIUS request s3, the attribute CHAP-Password is not inserted into the Access-Request type RADIUS request s3; and
in the alternative implementation of authentication in which the challenge was generated by the RADIUS server 120 in the step 2, and if the attribute CHAP-Challenge is not sent in the RADIUS Access-Request type request s3, said request comprises an attribute which has the name User-Password. The value of the attribute User-Password consists of the identity of the PPP CHAP message s1 specified in the field c2 of the PPP CHAP message s1 and the response to the challenge received in the PPP CHAP response message s2 in step 4.

At the end of step 4, the NAS 110 sends the RADIUS server 120 the Access-Request type RADIUS request s3.

In a step 5, following on from reception of the Access-Request type RADIUS request s3 sent in step 4, the RADIUS server 120 verifies the authentication of the user. For this it calculates an authentication value using the same hashing function MD5 as the peer 100, which it applies to a byte stream consisting of the challenge present in the attribute CHAP-Challenge of the Access-Request type RADIUS request s3 followed by the secret of the user that it is holding and the identity of the PPP CHAP message s1 present in the attribute CHAP-password of the Access-Request type RADIUS request s3. The RADIUS server 120 compares the authentication value to the response to the challenge present in the attribute CHAP-Challenge of the Access-Request type RADIUS request s3. In the alternative implementation of authentication in which the challenge was generated by the RADIUS server 120 in the step 2 and the challenge was not sent in the Access-Request type RADIUS request s3, the authentication server uses the challenge that it is holding to calculate the authentication value and the content of the attribute User-Password that contains the response to the challenge to verify the authentication. If the authentication value is equal to the response to the challenge then authentication has succeeded; if not, it has failed. In both cases, at the end of step 5, the RADIUS server 120 sends a message s4 to the NAS 110 specifying the result of the authentication. When authentication is successful, the message s4 is an Access-Accept type RADIUS response. If authentication has failed, the message s4 is an Access-Reject type RADIUS response.

In a step 6, following on from reception of the message s4, the NAS 110 generates a response message s5 for the attention of the peer 100. The message s5 is a CHAP-Success type PPP CHAP message if authentication has succeeded and a CHAP-Failure type PPP CHAP message if authentication has failed. At the end of the step 6, the NAS 110 sends the response message s5 to the peer 100.

In a step 7, following on from reception of the response message s5, the peer 100 is either authorized or not authorized to access the physical resource.

FIG. 4 illustrates the authentication mechanism conforming to the prior art EAP MD5-Challenge method by showing the exchange of messages between the three entities that the authentication method concerns. A peer 130 seeking to access a physical resource of the network addresses itself to an authenticator 140 which controls access to the physical resource. An authentication server 150 is responsible for authentication of the peer 130.

An EAP request or response message conforms to the format illustrated by FIG. 2.

In a initial step 11, the authenticator 140 sends the peer 130 an EAP identity request S10. In accordance with the EAP message format described with reference to FIG. 2, the message contains in the field c10 a value that corresponds to the type Identity.

In a step 12, following on from reception of the EAP identity request S10, the peer 130 constructs an EAP response message s11 that contains the identity of the peer 130 in the field c11 of the EAP response message s11. The peer 130 sends the EAP response message s11 to the authenticator 140.

In a step 13, following on from reception of the EAP response message s11, the authenticator relays the EAP response message s11 to the authentication server 150 in an EAP response message s12.

In a step 14, following on from reception of the EAP response message s12, the authentication server 150 generates a challenge and an EAP request message s13 of the EAP MD5-Challenge type. The EAP request message s13 contains the challenge in the field c13 of the message. In addition to the challenge it is possible to specify in the field c14 the identity of the authentication server originating the request message. The authentication server 150 sends the EAP request message s13 to the authenticator 140.

In a step 15, following on from reception of the EAP request message s13, the authenticator 140 relays the EAP request message s13 to the peer 130 in an EAP request message s14.

In a step 16, following on from reception of the EAP request message s14, the peer 130 extracts the challenge from the EAP request message s13 and uses it to construct a response. The response is calculated by applying the MD5 hashing function to a byte stream consisting of the challenge followed by the secret held by the peer 130 and the identifier of the request message s14 recovered from the field c8 of the message. The peer 130 sends to the authenticator 140 an EAP response s15 that contains the response to the challenge in the field c13. The field c14 of the EAP response s15 can be used to specify the identity of the peer 130 that sends the response.

In a step 17, following on from reception of the EAP response message s15, the authenticator 140 relays the EAP response message s15 to the authentication server 150 in an EAP response message s16.

In a step 18, following on from reception of the EAP response message s16, the authentication server 150 verifies the authentication of the peer 130. To this end it calculates an authentication value by applying the MD5hashing function to a byte stream consisting of the challenge that it generated in the step 14 followed by the secret specific to the peer 130 that it is holding and the identifier of the request and response messages that appears in field c8 of the EAP response message s16. If the authentication value is equal to the response to the challenge that appears in the field c17 of the EAP response message s16, then authentication of the peer 130 has succeeded; if not, it has failed. In both cases, the authentication server 150 generates an EAP message s17 specifying the authentication result. When authentication is successful, the EAP message s17 is an EAP message of the EAP Success type. If authentication fails, the EAP message s17 is an EAP message of the EAP Failure type. The authentication server 150 sends the EAP message s17 to the authenticator 140.

In a step 19, following on from reception of the EAP message s17 sent by the authentication server 150 in the step 18, the authenticator 140 relays the EAP message s17 to the peer 130 in the EAP message s18.

In a step 20, following on from reception of an EAP message s18, the peer 130 either has access to the physical resource or does not.

In one particular implementation of EAP authentication, all EAP messages exchanged between the authenticator 140 and the authentication server 150 are encapsulated in messages conforming to an AAA (Authentication, Authorization, and Accounting) type protocol, for example the RADIUS protocol.

FIG. 5 illustrates an authentication mechanism that uses a method in accordance with the invention for translating EAP MD5-Challenge authentication messages into PPP CHAP-RADIUS authentication messages, by showing the exchange of messages between the entities that the authentication method concerns and processing operations. The EAP terminology is used again to designate the entities that the authentication method concerns.

An EAP peer 160 corresponds to the client to be authenticated that wishes to access the physical resource and must be authenticated to do so. An authenticator 170 is the authenticator system that controls access to the physical resource. A translator 180 specific to the present invention implements the method according to the invention and translates authentication messages conforming to the EAP protocol and to the EAP MDT-Challenge method into messages conforming to the PPP CHAP-RADIUS authentication protocol. A translation module 181 is a program intended to be stored in a memory of the translator 180; it includes instructions for implementing the translation method according to the invention. It manages an internal data item 182 called the current EAP conversation context for storing information on the EAP conversation in progress, for example, and non-exhaustively, an identifier of the EAP conversation in progress, the EAP authentication method chosen for the conversation in progress. This information is received during exchanges with the authenticator 170 and a RADIUS server 190. The RADIUS server 190 is responsible for authenticating the EAP peer 160. This RADIUS server does not have the EAP function enabling it to authenticate EAP clients.

In one particular embodiment of the invention, all messages exchanged between the peer 160 and the authenticator 170 are encapsulated in a secure tunnel, for example in EAP-TTLS messages.

In one particular embodiment of the invention, all messages exchanged between the authenticator 170 and the translator 180 are encapsulated in messages conforming to an AAA-type protocol, for example the RADIUS protocol.

In an initial step 22, the authenticator 170 generates an identity request message s20 and sends it to the EAP peer 160. According to the EAP message format described with reference to FIG. 2, the message contains in the field c10 a value that corresponds to the type Identity.

In a step 23, following on from reception of the EAP identity request message s20, the EAP peer 160 generates and sends an EAP response message s21 containing its identity in the field c11.

In a step 24, following on from reception of the EAP response message s21, the authenticator 170 relays the EAP response message s21 to the translator 180 in an EAP message s22.

In a step 25, following on from reception of the EAP response message s22, the translator 180 analyses the EAP response message s22. The translator 180 recovers the identity of the EAP peer 160 to be authenticated from the field c11 of the EAP response message s22 and stores that identity in the current EAP conversation context 182. The current EAP conversation context 182 is uniquely identified, among other things by an identifier that appears in the field c8 of the EAP response message s22 of the Identity type. The translator 180 chooses an authentication method of the current EAP conversation, which here is the EAP MD5-Challenge method. The choice of the EAP MD5-Challenge method is the result of various considerations: the identity of the EAP peer 160, an identifier of the authenticator 170, and any further information available to the translator 180 enabling it to characterize the user associated with the peer 160 and the authenticator 170 that is the access point. The information that characterizes the user and the access point to the network is advantageously stored in the current EAP conversation context 182. The translator 180 stores the choice of the EAP MD5-Challenge method in the current EAP conversation context 182. The translator 180 chooses to translate the EAP MD5-Challenge authentication into PPP CHAP-RADIUS in order to externalize the authentication to a RADIUS server 190 that does not have the EAP function. The translator chooses the RADIUS server it wishes to perform the authentication. To make this choice, the translator 180 relies on information on the EAP peer available to it: the identity of the EAP peer stored in the current EAP conversation context 182 and any other information available to the translator 180 via access to another server or a database and that characterizes the user associated with the EAP peer 160 and the authenticator 170 that is the access point to the network. This information is stored in the current EAP conversation context 182. The translator 180 determines that it must ask the RADIUS server 190 to generate a challenge and sends a Access-Request type RADIUS request s23 to the RADIUS server 190. In an alternative embodiment of the invention, the translator 180 chooses to generate the challenge itself. There is then no exchange of messages with the RADIUS server 190.

In a step 26, following on from reception of the Access-Request type RADIUS request s23, the RADIUS server 190 generates the challenge and sends the translator 180 an Access-Challenge type RADIUS response s24 that contains the challenge in a RADIUS attribute Reply-Message.

In a step 27, following on from reception of the RADIUS response s24, the translator 180 generates an EAP challenge message s25. The challenge received from the RADIUS server 190 in the RADIUS response s24 is inserted into the field c13 of an EAP challenge message s25. In the alternative embodiment of the invention in which the translator 180 chooses to generate the challenge itself, the challenge is inserted into the field c13 of the EAP challenge message s25 and stored in the current EAP conversation context 182. The translator 180 stores the manner in which the challenge was generated in the current EAP conversation context 182.

The field c14 of the EAP challenge message s25 is advantageously used to the specify the identity of the authentication server 190 that generated the challenge. In the alternative embodiment of the invention in which the translator 180 chooses to generate the challenge itself, the field c14 of the EAP challenge message s25 is advantageously used to specify the identity of the translator 180 originating the EAP challenge message s25. The translator 180 sends the EAP challenge message s25 to the authenticator 170 at the end of the step 27.

In a step 28, following on from reception of the EAP challenge message s25, the authenticator 170 relays the EAP challenge message s25 to the EAP peer 160 in an EAP challenge message s26.

In a step 29, following on from reception of the EAP challenge message s26, the EAP peer 160 extracts the challenge from the field c13 of the EAP challenge message s26 and generates an EAP response message s27. To do this, the EAP peer 160 calculates a response to the challenge by applying the MD5 hashing function to a byte stream consisting of the value of the challenge, followed by a secret specific to the EAP peer 160, followed by the identity of the message s26 extracted from the field c8 of the EAP challenge message s26. The response to the challenge is inserted into the field c13 of the EAP response message s27. The field c14 of the EAP response message s27 can advantageously be used to specify the identity of the EAP peer 160. The EAP peer 160 sends the EAP response message s27 to the authenticator 170.

In a step 30, following on from reception of the EAP response message s27, the authenticator 170 relays the EAP response message s27 to the translator 180 in a message s28.

In a step 31, following on from reception of the EAP response message s28, the translator 180 analyses the EAP response message s28. It recovers the response to the challenge from the field c13 and the name of the entity that sent the message from the field c14, if it has been filled in. The translator stores the response to the challenge and, where applicable, the identity of the entity that sent the message in the current EAP conversation context 182. In an alternative embodiment of the invention, in which the choice to externalize authentication to a RADIUS server was not made during the step 25, that choice is made now, as well as the choice of the RADIUS server. To make this choice, the translator 180 relies on information on the EAP peer 160 available to it: the identity of the EAP peer 160 stored in the current EAP conversation context 182, the sender of the response message to the challenge request, and any other information available to the translator 180 via access to another server or a database and that characterizes the user associated with the EAP peer 160 and the authenticator 170 that is the access point to the network. The translator 180 constructs an Access-Request type RADIUS request s29 that contains authentication information needed by the RADIUS server 190 to authenticate the EAP peer 160. In particular, the translator 180 uses authentication information recovered in previous steps to generate the following RADIUS authentication attributes:
an attribute User-Name that corresponds to the identity of the user associated with the EAP peer 160. The identity of the user is, for example, and non-exhaustively, a MAC (Media Access Control) address, an IP address of the EAP peer 160 or the identity inserted into the field c14 of the message s27 by the EAP peer. The value of this attribute is obtained from information contained in fields of messages previously exchanged and stored in the current EAP conversation context 182 as and when exchanged. The translator 180 uses all or some of this information to construct the attribute User-Name:
the field c11 of the EAP response message s22 to the identity request received by the translator 180 in the step 25. In one particular embodiment of the invention in which the EAP response message s22 is encapsulated in a RADIUS message, a copy of the field c11 is contained in the attribute User-Name of the RADIUS message s22;
the field c14 of the EAP response message s28 that advantageously contains the identity of the EAP peer 160; and
any other information for identifying the user.
   In one particular embodiment of the invention in which EAP messages exchanged between the authenticator 170 and the translator 180 are encapsulated in an AAA-type protocol, for example the RADIUS protocol, attributes of that protocol are advantageously used.

In one particular embodiment of the invention, the translator 180 adds to the attribute User-Name or creates an identifier from information specific to the user that it holds, for example information stored in a database to which the translator 180 has access.
an attribute CHAP-Password that specifies the identifier of the EAP response message s28 and the response to the challenge extracted from the field c13 of the EAP response message s28. The CHAP-Password attribute is filled in when the challenge is stored by the translator 180 and sent to the RADIUS server 190 in the RADIUS request s29, in a CHAP-Challenge RADIUS attribute or in the Authenticator field of the RADIUS request s29.
an attribute User-Password that contains the identifier of the EAP response message s28 and the response to the challenge extracted from the field c13 of the EAP response message s28. The attribute User-Password is filled in when the challenge is not sent by the translator 180 to the RADIUS server 190 in the RADIUS request s29.

In the alternative embodiment of the invention in which the translator 180 generates the challenge itself, the translator 180 specifies the value of the challenge in a CHAP-Challenge attribute or in the authenticator field of the RADIUS request s29 and the identifier of the EAP response message s28 and the response to the challenge extracted from the field c13 of the EAP response message s28 in an attribute CHAP-Password.

In one particular embodiment of the invention, the translator 180 also carries out additional proxy-type processing. Accordingly, information known to the translator 180 is sent to the RADIUS server 190 in RADIUS attributes. The information is, for example, and non-exhaustively, information specified by the translator 180 associated with the authenticator 170 or the EAP peer 160 and that could be useful to the RADIUS server.

The Access-Request type RADIUS request s29 constructed by the translator 180 is sent at the end of step 31 to the RADIUS server 190.

In a step 32, following on from reception of the Access-Request type RADIUS request s29, the authentication server 190 verifies the authentication of the user in the same way as for the PPP CHAP method.

The RADIUS server 190 sends an authentication result message s30 to the translator 180. The authentication result message s30 is an Access-Accept type RADIUS response if authentication has succeeded and a RADIUS response Access-Reject in the event of failure.

In a step 33, following on from reception of the authentication result message s30, the translator 180 analyses the authentication result message s30 and prepares to translate said message s30 into an EAP message. Preparing for the translation consists in choosing a message to send to the authenticator system as a result of authentication. The translator chooses the response message as a function of the RADIUS response received and/or values of RADIUS attributes of the RADIUS response and/or conditions internal to the translator. In one embodiment of the invention, the translator generates a response message s31 that is an EAP-Success type EAP message if the message s30 is an Access-Accept type RADIUS response and an EAP-Failure type EAP message if the message s30 is an Access-Reject type RADIUS response. In one particular embodiment of the invention, proxy-type processing is also possible for adapting the response message s31 as a function of criteria defined in the translator 180. The response message s31 is sent to the authenticator 170 at the end of the step s33.

In a step 34, following on from reception of the response message s31, the authenticator 170 relays the EAP-Success or EAP-Failure type EAP response message s31 to the EAP peer 160 in a message s32.

In a step 35 following on from reception of the message s32, the EAP peer 160 accesses the physical resource or not.

For clarity, mechanisms specific to the EAP and RADIUS protocols linked to retransmission of messages and to storing information necessary for such retransmission are not described.

FIG. 6 illustrates the exchanges of messages that take place in a second variant of the translation method according to the invention in which the functions of the translator as described with reference to FIG. 5 are integrated into the authenticator system. An EAP peer 200 is the client to be authenticated. An authenticator-translator 210 is the authenticator system that controls access to the physical resource and integrates the functions of the translator. A RADIUS server 220 controls access by the EAP peer 200.

The steps 41, 42, 44, 46, 48, 50 are identical to/of the same type as the steps 22, 23, 26, 29, 32, 35 described with reference to FIG. 5.

In a step 43, comparable to the step 25 in FIG. 6, the authenticator-translator 210 determines that the EAP authentication method to be used is the EAP MD5-Challenge method and that it must ask the RADIUS server 220 to generate a challenge. The authenticator-translator 210 sends an Access-Request type RADIUS request s42 to the RADIUS server 220. In an alternative embodiment of the invention, the authenticator-translator 210 chooses to generate the challenge itself. There is then no exchange of messages with the RADIUS server 220.

In a step 45 following on from reception of an Access-Challenge type RADIUS response s43 (which is of the same type as the response s24 in FIG. 5) that contains the challenge requested in the step 43, the authenticator-translator 210 generates an EAP challenge message s44. The challenge received from the RADIUS server 220 in the Access-Challenge type RADIUS response s43 is inserted into the field c13 of an EAP challenge message s44.

In an alternative embodiment of the invention in which the authenticator-translator 210 generates the challenge itself, the challenge is inserted into the field c13 of the EAP challenge message s44.

The identity of the authenticator-translator 210 is advantageously specified in the field c14 of the EAP challenge message s44. The EAP challenge message s44 is sent to the EAP peer 200 at the end of step 45.

In a step 47, following on from reception of an EAP response message s45 (which is of the same type as the message s27 in FIG. 5), processing comparable to that effected by the translator in the step 31 in FIG. 5 is carried out. The authenticator-translator 210 generates an Access-Request type RADIUS request s46 from authentication information contained in the EAP messages exchanged in the previous steps. The Access-Request type RADIUS request s46 comprises a plurality of RADIUS attributes:
an attribute User-Name in which the authenticator-translator 210 inserts the identifier of the user associated with the EAP peer 200, which can consist of information recovered from the field c11 of the EAP message s41 and the field c14 of the EAP message s41. In one particular embodiment of the invention, the authenticator-translator 210 completes the User-Name attribute or creates an identifier from information specific to the user that it holds, for example information stored in a database to which the authenticator-translator 210 has access.
an attribute CHAP-Password into which the authenticator-translator 210 copies the identifier of the EAP response message s45 that is the identifier of the current EAP conversation and the response to the challenge extracted from the field c13 of the EAP response message s45. The attribute CHAP-Password is filled in when the challenge is stored by the authenticator-translator 210 and sent to the RADIUS server 220 in the RADIUS request s46, in a RADIUS attribute CHAP-Challenge, or in the Authenticator field of said request.
an attribute User-Password that contains the identifier of the response message s45 and the response to the challenge extracted from the field c13 of the EAP response message s45. The attribute User-Password is filled in when the challenge is not sent by the authenticator-translator 210 to the RADIUS server 220 in the RADIUS request s46.

In the alternative embodiment of the invention in which the authenticator-translator 210 generates the challenge itself, the authenticator-translator 210 specifies the value of the challenge in a CHAP-Challenge attribute or in the Authenticator field of the RADIUS request s46 and the identifier of the EAP response message s45 and the response to the challenge extracted from the field c13 of the EAP response message s45 in a CHAP-Password attribute.

In one particular embodiment of the invention proxy-type additional processing is also carried out by the authenticator-translator 210 that sends the RADIUS server 220 information in RADIUS attributes. The EAP response message s46 is sent to the RADIUS server 220.

In a step 49, following on from reception of an authentication result message s47 (which is of the same type as the message s30), the authenticator-translator 210 generates for the attention of the EAP peer 200 a response message s48 which is an EAP message EAP-Success when the message s47 is an Access-Accept type RADIUS response and an EAP message EAP-Failure when the message s47 is an Access-Reject type RADIUS response. In one particular embodiment of the invention, proxy-type processing is also possible to adapt the response message s48 as a function of criteria defined in the authenticator-translator 210.

In a step 50, following on from reception of the response message s48 the EAP peer 200 either accesses the physical resource or does not.

FIG. 7 is a diagram representing one example of a network architecture in which the entities involved in the translation method according to the invention are represented.

The EAP peer 160 is seeking to access a physical resource of an IP network 250 controlled by the authenticator 170 that constitutes an access point to the network. The EAP peer 160 must be authenticated beforehand. The RADIUS server 190 verifies that the EAP peer 160 has been authenticated and has the right to access the physical resource of the network 250. The RADIUS server 190 does not have the EAP function.

In order to be authenticated, the EAP peer 160 dialogues with the authenticator 170 in accordance with the EAP MD5-Challenge authentication method. The authenticator 170 asks the RADIUS server 190 to verify if the EAP peer 160 has the right to access the resource. To do this, the EAP peer 160 dialogues with the translator 180, specific to the invention, which translates EAP MD5-Challenge authentication messages into PPP CHAP-RADIUS authentication messages understandable by the RADIUS server 190. The translator 180 supplies the RADIUS server 190 with the authentication data specific to the EAP peer 160 received from the authenticator 170. It receives the authentication result from the RADIUS server 190. It translates this result for the attention of the authenticator 170. The authenticator 170 informs the EAP peer 160 of the authentication result.

FIG. 8 is a diagram representing a second variant of the network architecture in which the entities involved in the translation method according to the invention are represented. In this variant it is the authenticator-translator 210, specific to the invention, that is the authenticator system that performs the functions of the authenticator 170 and the translator 180 in FIG. 7.

FIG. 9 is a diagram illustrating the functional organization of a translator and an authenticator-translator according to the invention.

The translator 180 consists of the following main functional modules:
a module 281 for obtaining a challenge that is a random value. The challenge is generated by the module or obtained by the module following a generation request submitted to an authentication server.
a module 282 for sending messages. This module is responsible for sending to an external entity messages prepared by a message processing module or the module 281 for obtaining a challenge. To this end it has a number of external interfaces: an interface i282-1 for sending messages to an authentication server and an interface i282-3 for sending messages to an authenticator.
a module 283 for receiving messages. This module receives messages from external entities via a number of interfaces: an interface i283-1 for receiving messages sent by the authenticator and an interface i283-3 for receiving messages from the authentication server. It transmits the received messages to a processing module.
a processing module 284. This module analyses the messages received from the message reception module 283, translates authentication data from one protocol to another, and generates messages to be sent by the message sending module 282.
a module 285 for choosing an authentication method supported by EAP.

A communication channel 288 is used by the modules to exchange information. For example, the module 281 for obtaining a challenge can send the module 282 for sending messages a challenge request that the module 282 for sending messages sends to an authentication server.

The authenticator-translator 210 comprises the same functional modules as the translator 180. The module 282 for sending messages differs from that of the translator 180 in that it has an interface i282-2 it uses to send messages for the attention of a peer and in that it does not have the interface i282-3 with the authenticator. The message receiving module 283 of the authenticator-translator 210 differs from that of the translator 180 in that it does not have the interface i283-1 with the authenticator and in that it has an interface i283-2 it uses to receive messages from the peer.

The functional blocks described above and the interfaces are advantageously implemented in the form of programs stored in a memory of the translator 180, respectively the authenticator-translator 210, and executed by a processor of said translator, respectively said authenticator-translator.

FIG. 10 is a diagram that shows the main components of a translator 180 according to the invention.

The main calculations are effected in a central component 360 called the central processor unit (CPU). In particular, the CPU 360 executes programs loaded into a random access memory (RAM) 365 that stores data to be processed by the CPU.

Peripherals 370 handle communications between the processor and the outside world. They are not shown in detail in the diagram for clarity. For example, and non-exhaustively, a peripheral is a network connection module, a removable disc, etc.

A bus 375 is used to transfer data between the components of the translator 180.

A translation program 380 specific to the invention is stored in a peripheral not represented in the diagram. It comprises functional modules described with reference to FIG. 9 and implemented in the form of program instructions. It is loaded into the random access memory 365 for execution of the instructions by the CPU.

FIG. 10 applies equally to an authenticator-translator 210 as shown in FIG. 6. The main components of the authenticator-translator are identical to those of the translator 180. Only the translation program 380 is different. With the authenticator-translator, a specific program comprises functional modules described with reference to FIG. 9 implemented in the form of program instructions. Said program is loaded into the random access memory 365 for execution of the instructions by the CPU.

1. A method of translating messages conforming to a first authentication protocol into messages conforming to a second authentication protocol during an authentication phase in which a peer (160), having an identity and seeking to access a resource of a network (250), is connected to an authenticator (170), said authenticator authorizing access to the network as a function of verification of the identity and rights of the peer effected by an authentication server (190) as a function of authentication data received in messages conforming to the second authentication protocol, wherein the translation method comprises:
a step (25) of receiving the identity of the peer in a message conforming to the first authentication protocol;
a step (27) of generating and sending a challenge;
a step (31) of receiving a first response that is a response to said challenge, generating, from a first response, a request for access to the network conforming to the second authentication protocol, and sending said request to the authentication server; and
a step (33) of receiving a second response that is a response to said request and translating the second response to generate an authentication result conforming to the first authentication protocol.

2. A The method according to claim 1, comprising a step of choosing an authentication method supported by the first authentication protocol.

3. The method according to claim 1, wherein generating the challenge comprises:
a step (25) of requesting said challenge from the authentication server (190); and
a step (27) of receiving said challenge.

4. A method of authenticating a peer (200) having an identity and which, to access a resource of a network (250), is connected to an authenticator-translator (210) conforming to a first authentication protocol, said authenticator-translator authorizing access to the network as a function of verification of the identity and rights of the peer effected by an authentication server (220) as a function of authentication data received in messages conforming to a second authentication protocol, the method comprising:
a step (41) of sending an identity request to the peer;
a step (43) of receiving the identity of the peer in a message conforming to the first authentication protocol;
a step (45) of generating and sending a challenge;
wherein the authenticating method integrates functions for translating messages conforming to the first authentication protocol into messages conforming to the second authentication protocol, and wherein the authenticating method further comprises:
a step (47) of receiving a first response that is a response to said challenge, generating, from the first response, a network access request conforming to the second authentication protocol, and sending said request to the authentication server; and
a step (49) of receiving a second response that is a response to said request, translating the second response to generate an authentication result conforming to the first authentication protocol, and sending said authentication result.

5. A translator device adapted to translate messages conforming to a first authentication protocol into messages conforming to a second authentication protocol during an authentication phase in which a peer (160), having an identity and seeking to access a resource of a network (250), is connected to an authenticator (170), said authenticator authorizing access to the network as a function of verification of the identity and rights of the peer effected by an authentication server (190) as a function of authentication data received in messages conforming to the second authentication protocol, wherein the translator device comprises:
a module (281) for obtaining a challenge;
a module (282) for sending said challenge and a network access request;
a module (283) for receiving the identity of the peer, a first response that is a response to said challenge, and a second response that is a response to said network access request; and
a processor module (284) that generates, from the first response, the network access request conforming to the second authentication protocol and translates an authentication result conforming to the first authentication protocol.

6. The device according to claim 5, further comprising a module (281) for choosing an authentication method supported by the first authentication protocol.

7. An authenticator-translator device (210) adapted to authenticate a peer (200) having an identity and which, for access to a resource of a network (250), dialogues with said device in accordance with a first authentication protocol, said device authorizing access to the network as a function of verification of the identity and rights of the peer effected by an authentication server (220) as a function of authentication data received in messages conforming to the second authentication protocol, the device comprising:
a module (281) for obtaining a challenge;
a module (282) for sending a peer identity request, said challenge, a network access request, and an authentication result; and
a module (283) for receiving said identity, a first response that is a response to said challenge, and a second response that is a response to said network access request;
wherein the authentication-translator device is adapted to translate messages conforming to the first authentication protocol into messages conforming to the second authentication protocol, and wherein the authentication-translator device further comprises:
a processor module (284) that generates, from the first response, the network access request conforming to the second authentication protocol and translates an authentication result conforming to the second authentication protocol.

8. An authentication system comprising a peer (160, 200) seeking to access a resource of a network (250) and that must be authenticated by an authenticator system (170, 210) by sending authentication data conforming to a first authentication protocol, received and verified by an authentication server (190, 220) in accordance with a second authentication protocol, wherein the authentication system comprises:
means for translating the authentication data of the first protocol into authentication data of the second protocol; and
means for authenticating the client.

9. An authentication system comprising a peer (160, 200) seeking to access a resource of a network (250) and that must be authenticated by an authenticator system (170, 210) by sending authentication data in accordance with a first authentication protocol, received and verified by an authentication server (190, 220) in accordance with a second authentication protocol, wherein the means for translating the authentication data of the first protocol into authentication data of the second protocol are provided by the translator device according to claim 5.

10. An authentication system comprising a peer (160, 200) seeking to access a resource of a network (250) and that must be authenticated by an authenticator system (170, 210) by sending authentication data in compliance with a first authentication protocol, verified by an authentication server (190, 220) in accordance with a second authentication protocol, wherein the means for translating the authentication data of the first protocol into authentication data of the second protocol and the means for authenticating the client are provided by the authenticator-translator device according to claim 7.

11. A computer program including instructions for executing a method according to claim 1 when it is executed by a microprocessor (360).

12. A computer program including instructions for executing a method according to claim 4 when it is executed by a microprocessor (360).
